(19) United States
(12) Patent Application Publication
(10) Pub. No.: US 2007/0071786 A1
(43) Pub. Date: Mar. 29, 2007

(54) Wax emulsion compositions for attracting insects and methods of using the same

(75) Inventor: Joan Fisher, Bend, OR (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Suterra LLC, Bend, OR (US)

(21) Appl. No.: 11/237,311

(22) Filed: Sep. 27, 2005

(51) Int. Cl. A01N 25/08

(52) U.S. Cl. 424/410

(57) ABSTRACT

Attractant compositions suitable for attracting fruit flies are described. The compositions are preferably provided in the form of a wax emulsion of the attractant. Both chemical attractants—such as ammonium acetate and ammonium bicarbonate—and food-based attractants—such as protein and yeasts—are described. Insect lures and traps comprising the disclosed compositions are also described.

### FIELD OF THE INVENTION

The present invention relates generally to compositions for attracting insect populations, and more particularly, to wax emulsion compositions suitable for monitoring insect populations.

### BACKGROUND OF THE INVENTION

Tephritid fruit flies including those of the Ceratitis spp., Anastrepha spp., Bactrocera spp., Rhagoletis spp., and Dacus spp. pose a serious threat to several hosts worldwide such as citrus, plums, peaches, mangos, and guavas. In certain locations, such as Mexico and Guatemala, these pests are subject to strict monitoring protocols in order to ensure that their populations are sufficiently controlled to protect vulnerable crops.

Traps have been developed to capture and kill fruit flies as well as to facilitate the monitoring of their populations. These traps typically include a lure with an attractant composition that attracts a targeted insect species or groups of species. The attractant composition typically releases a volatile material or materials which attracts insects to the trap. However, many known traps have suffered from an inability to provide a sustained, controlled release of volatile attractants. Moreover, the inability of such known traps to provide a controlled release has also limited the amount of attractant which can be dispensed. Accordingly, there is a need to overcome the issues noted above.

### SUMMARY OF THE PREFERRED EMBODIMENTS

In accordance with a first aspect of the present invention, a lure is provided which comprises a first attractant composition and a first synergist composition. The first attractant composition preferably comprises a first attractant and a first wax, and the first synergist composition preferably comprises a first synergist and a second wax.

In preferred embodiments, the lure comprises a second synergist composition which comprises a second synergist and a third wax. In other preferred embodiments, the first wax is a paraffin. In additional preferred embodiments, the first attractant is one selected from the group consisting of a chemical attractant, a food-based attractant, and mixtures thereof. In yet additional preferred embodiments, the first attractant is one selected from the group consisting of ammonium acetate, ammonium bicarbonate, protein, yeast, and mixtures thereof.

In further preferred embodiments, the first attractant is ammonium acetate and the first synergist is trimethyl amine. In yet additional preferred embodiments, the first attractant is ammonium acetate and the first synergist is putrescine. In still other preferred embodiments, the first attractant is ammonium acetate, the first synergist is trimethyl amine, and the second synergist is putrescine. In additional preferred embodiments, the lure comprises a first dispensing section and a second dispensing section, the first attractant composition is disposed in the first dispensing section, and the first synergist composition is disposed in the second dispensing section. In other preferred embodiments, at least one selected from the group consisting of the first attractant composition and the first synergist composition is an emulsion.

In further preferred embodiments, the lure comprises a first dispensing section, a second dispensing section, and a third dispensing section. The first attractant composition is disposed in the first dispensing section, the first synergist composition is disposed in the second dispensing section, and the second synergist composition is disposed in the third dispensing section. In yet further preferred embodiments, the first attractant composition and the first synergist composition are each an emulsion.

In other preferred embodiments, the first attractant is present in an amount sufficient to attract an insect species. In still other preferred embodiments, the insect species is at least one selected from the group consisting of Ceratitis, Bactrocera oleae, Anastrepha, Rhagoletis, and Dacus.

In additional preferred embodiments, the first attractant is present in an amount greater than about one (1) percent by weight. In further preferred embodiments, the first synergist is present in an amount greater than about one (1) percent by weight.

In other preferred embodiments, the lure releases ammonia at a rate from about 100 micrograms per hour to about 600 micrograms per hour. In still other preferred embodiments, the rate of release of ammonia is substantially constant during a fixed period of time.

In accordance with another aspect of the present invention, an insect trap is provided. The insect trap preferably comprises a lure having a first attractant composition and a first synergist composition. The first attractant composition comprises a first attractant and a first wax, and the first synergist composition comprises a first synergist and a second wax. In preferred embodiments, the trap further comprises an insect retention agent. In yet further embodiments, the insect retention agent is one selected from the group consisting of 2,2 dichlorovinyl dimethyl phosphate, water, a mixture of water and surfactant, a mixture of water and propylene glycol, and a mixture of water and borax.

In accordance with a further aspect of the present invention, a composition is provided which comprises a wax and an attractant selected from the group consisting of ammonium acetate, ammonium bicarbonate, protein yeast, and mixtures thereof, wherein the attractant is present in an amount ranging from greater than 1.0 percent by weight to less than 50 percent by weight. In preferred embodiments, the amount of attractant is from about 5 percent to less than 50 percent by weight of the composition. In other preferred embodiments, the amount of wax is from about 40 percent to about 60 percent by weight of the composition.

In accordance with yet another aspect of the present invention a method of monitoring an insect population in location is provided. The method comprises providing an insect trap including a lure. The lure preferably comprises a first attractant composition and a first synergist composition. The first attractant composition preferably comprises a first attractant and a first wax. The first synergist composition preferably comprises a first synergist and a second wax. The method further comprises placing the trap in the location for a period of time, wherein a number of insects are contained in the trap at the end of the period, and determining the number of insects contained in the trap. In preferred embodiments, the period of time is a first period of time, the number of insects is a first number of insects, and the method further comprises placing the trap in the location for a second period of time, wherein a second number of insects are contained in the trap at the end of the second period, and determining the second number of insects contained in the trap.

In other preferred embodiments, the trap comprises an insect retention agent. In additional preferred embodiments, the insect retention agent is one selected from the group consisting of 2,2 dichlorovinyl dimethyl phosphate, water, a mixture of water and surfactant, a mixture of water and propylene glycol, and a mixture of water and borax. In other preferred embodiments, the first attractant is selected from the group consisting of ammonium acetate, ammonium bicarbonate, protein, yeast, and mixtures thereof. In still other preferred embodiments, the first attractant is ammonium acetate and the first synergist is trimethyl amine. In additional preferred embodiments, the first attractant is ammonium acetate and the first synergist is putrescine. In yet further preferred embodiments, the lure further comprises a second synergist composition comprising a second synergist and a third wax, the first attractant is ammonium acetate, the first synergist is trimethyl amine, and the second synergist is putrescine.

In other preferred embodiments, the first attractant is present in an amount sufficient to attract an insect species. In still other preferred embodiments, the insect species is at least one selected from the group consisting of Ceratitis, Bactrocera, Anastrepha, Rhagoletis, and Dacus.

In accordance with still another aspect of the present invention, a composition for attracting insects is provided. The composition comprises an attractant, present in an amount ranging from greater than 1.0 to less than 50 percent by weight, and a wax. In preferred embodiments, the attractant is one selected from a chemical attractant, a food-based attractant, and mixtures thereof. In other preferred embodiments, the attractant is one selected from the group consisting of ammonium acetate, ammonium bicarbonate, protein, yeast, and mixtures thereof. In additional preferred embodiments, the composition further comprises a synergist. In other preferred embodiments, the synergist is a tri-substituted ammonia compound. In further preferred embodiments, the synergist is selected from the group consisting of trimethyl amine and putrescine. In other preferred embodiments, the attractant is present in an amount ranging from about 5 percent to about 40 percent by weight. In additional preferred embodiments, the attractant is present in an amount ranging from about 25 percent to about 35 percent by weight. In still other preferred embodiments, the composition further comprises an emulsifier.

In accordance with an additional aspect of the present invention, a composition for attracting insects is provided. The composition comprises an attractant and a wax, and the attractant is selected from the group consisting of protein, yeast, and mixtures thereof.

In accordance with a further aspect of the present invention, a lure is provided which comprises at least one wax emulsion composition formulated to release from about 100 micrograms per hour to about 600 micrograms per hour of ammonia. In preferred embodiments, the wax emulsion is formulated to release ammonia at a substantially constant rate during a fixed period of time. In other preferred embodiments, the at least one wax emulsion composition comprises two wax emulsion compositions.

### BRIEF DESCRIPTION OF THE DRAWINGS

The invention may be more readily understood by referring to the accompanying drawings in which:

FIG. 1 is a top perspective view of an insect lure configured in accordance with a preferred embodiment of the present invention;

FIG. 2 is a bottom perspective view of the insect lure of FIG. 1; and

FIG. 3 is a side elevational view of an insect trap in accordance with a preferred embodiment of the present invention.

Like numerals refer to like parts throughout the several views of the drawings.

### DETAILED DESCRIPTION OF THE PREFERRED EMBODIMENTS

The present invention relates to compositions which are suitable for attracting insect species. As described below, in an especially preferred embodiment, these compositions are incorporated into lures used in insect traps.

In accordance with a preferred embodiment of the invention, an attractant composition is provided which comprises an attractant and a wax. The attractant is preferably a chemical attractant or a food-based attractant which is targeted against an insect species of interest. Preferred chemical attractants include ammonium acetate and ammonium bicarbonate. Preferred food-based attractants include proteinaceous materials such as protein and yeast. Examples of suitable proteins include corn proteins such as NuLure, a product of the Miller Chemical Company, and SOLULYS®, a product distributed by Roquette America, Inc. Examples of suitable yeasts include Torula yeast.

The attractant is preferably present in an amount sufficient to attract an insect species. An“amount sufficient to attract an insect species” is defined as that amount of one or more attractants which attracts insects at a rate that is measurably higher than the number of insects attracted in the absence of the one or more attractants. The amount of attractant is generally greater than about one (1) percent by weight of the attractant composition, preferably from about five (5) percent to about 80 percent by weight of the attractant composition, and more preferably from about 25 percent to about 35 percent by weight of the attractant composition, with an attractant composition of about 30 percent by weight being especially preferred.

The chemical attractants may be provided in a dry form or in an aqueous solution. If they are provided in the form of an aqueous solution, the amounts described above are preferably the weight percent of the solution in the attractant composition (as opposed to the percentage of the attractant itself). The composition of aqueous chemical attractant solutions used in accordance with the present invention generally comprise from about 75 percent to about 95 percent attractant, preferably comprise from about 80 percent to about 90 percent by weight of attractant and more preferably comprise about 85 percent by weight of attractant, with the remainder being water.

Attractant compositions prepared in accordance with this preferred embodiment also preferably comprise a wax component, which more preferably is a paraffin wax. As used herein, the term“wax” refers to oily or greasy heat-sensitive substances that comprise hydrocarbons or esters of fatty acids and which are insoluble in water but soluble in nonpolar organic solvents. Suitable waxes include beeswax, vegetable based waxes such as soy wax (soy bean based), microcrystalline waxes, carnuba wax, cadelilla wax, fruit wax, lanolin, shellac wax, bayberry wax, sugar cane wax, ozocerite, ceresin, montan wax or and hydrocarbon based waxes such as GULF WAX® (Royal Oak Sales, Inc. Roswell, Ga.), a household paraffin wax. Gulf Wax is especially preferred. The wax component of this preferred embodiment preferably has a melting point ranging from about 158° F. to about 195° F., with a range of from about 160° F. to about 165° F. being especially preferred.

In an especially preferred embodiment, the foregoing attractant compositions are wax emulsion compositions. The wax emulsions preferably comprise a continuous wax phase and a discontinuous attractant phase. To stabilize the emulsion, one or more emulsifiers are preferably provided. Suitable emulsifers include carageenan, microcrystalline cellulose, sodium monostearate, lipids, lecithins, modified lecithins, sorbitans, monoglycerides, diglycerides, fatty acids, or combinations thereof. Suitable sorbitan emulsifiers include sorbitan fatty acid esters such as sorbitan monopalmitate, sorbitan monstearate, sorbitan, tristearate, sorbitan monooleate, sorbitan sesquioleate, and sorbtian trioleate. Span 60, a product of Uniqema (New Castle, Del.) is a sorbitan stearate emulsifier which is especially preferred.

Without wishing to be bound by any theory or limiting the scope of the claims in any way, it is believed that the incorporation of attractant compositions in a wax emulsion matrix provides a sustained, substantially constant release of volatile attractants. More specifically, it is believed that the incorporation of attractant compounds in a wax emulsion matrix alters the mechanism by which volatiles are released to provide substantially zero-order release rate kinetics, and therefore, a substantially uniform rate of release that is independent of the attractant concentration in the wax.

The wax emulsions of this preferred embodiment preferably comprise more than one emulsifier. It is especially preferred to use a combination of Span 60, microcrystalline cellulose, and carageenan. The total amount of emulsifier used is generally up to about 40 percent by weight of the attractant composition. An amount ranging from about three (3) percent to about 30 percent is preferred, and an amount ranging from about ten (10) percent to 20 percent is more preferred. In an especially preferred embodiment, the emulsifier comprises about three (3) percent by weight Span 60, about eight (8) percent by weight microcrystalline cellulose, and about five (5) percent by weight carrageenan, which is an emulsifier gum.

The attractant emulsion compositions of this preferred embodiment generally comprise up to about 70 percent by weight of wax, with wax amounts ranging from about 20 percent to about 60 percent being preferred and amounts ranging from about 45 percent to about 55 percent being more preferred. A wax amount ranging from about 45 percent to about 50 percent is especially preferred.

The attractant compositions of this preferred embodiment more preferably include an oil component to enhance the pliability of the emulsion. A variety of different oils such as vegetable oils and mineral oils may be used. However, soy oil is especially preferred. The amount of oil is generally from about 2 percent to about 10 percent by weight, with ranges of from about 4 percent to about 8 percent and from about 5 percent to about 7 percent being preferred and more preferred, respectively.

In accordance with another preferred embodiment of the present invention, a synergist composition is provided which preferably comprises a synergist and a wax. As used herein the term“synergist” refers to a compound or mixture of compounds that measurably increases the attractiveness of a chemical or food-based attractant. Thus, as explained in greater detail below, in an especially preferred embodiment of the present invention a lure is provided which comprises both an attractant composition and a synergist composition.

Preferred synergists include tri-substituted ammonia compounds such as trimethyl amine, as well as putrescine (1, 4 diamino butane). If trimethyl amine is used as a synergist, it is preferably provided in the same weight percentages recited above for ammonium acetate or ammonium bicarbonate attractants. If putrescine is used as a synergist, the amount of putrescine in the synergist composition is generally greater than about one (1) percent by weight, preferably from about five (5) percent to about 80 percent by weight, and more preferably from about eight (8) percent to about fifteen (15) percent by weight, with a putrescine composition of about ten (10) percent being especially preferred.

Synergist compositions prepared in accordance with preferred embodiments of the present invention preferably comprise a wax component. Paraffin wax is especially preferred, and the same waxes identified above with respect to the attractant compositions may be used for the synergist composition. If a trimethyl amine synergist is used, the amount of wax preferably comprises up to about 70 percent by weight of wax, with wax amounts ranging from about 20 percent to about 60 percent being preferred and amounts ranging from about 45 percent to about 55 percent being more preferred. A wax amount ranging from about 45 percent to about 50 percent is especially preferred. If a putrescine synergist is used, the synergist composition generally comprises from about 40 percent to about 95 percent by weight of wax, with amounts ranging from about 70 percent to about 95 percent and from about 88 percent to about 90 percent being preferred and more preferred, respectively.

The synergist compositions of this preferred embodiment are more preferably wax emulsions in which the synergist is the discontinuous phase and the wax is the continuous phase. To stabilize the wax emulsion, one or more of the emulsifiers described above are also preferably incorporated into the synergist composition. For trimethyl amine synergist compositions, it is especially preferred to use a combination of Span 60, microcrystalline cellulose, and carageenan (which is an emulsifier gum). The total amount of emulsifier used for trimethyl amine synergist composition is generally up to about 40 percent by weight of the synergist composition. Amounts ranging from about three (3) percent to about 30 percent are preferred, and amounts ranging from about ten (10) percent to 20 percent are more preferred. In an especially preferred embodiment, the trimethyl amine synergist composition comprises about three (3) percent by weight Span 60, about eight (8) percent by weight microcrystalline cellulose, and about five (5) percent by weight carageenan.

The putrescine synergist compositions also preferably comprise an emulsifier. It is especially preferred to use a microcrystalline cellulose emulsifier in an amount that is generally up to about 20 percent by weight of the synergist composition. Emulsifier ranges of from about four (4) percent to about 16 percent are preferred, and ranges of from about six (6) percent to about ten (10) percent are especially preferred. In an especially preferred embodiment, the putrescine synergist composition comprises about eight (8) percent by weight of microcrystalline cellulose.

Table 1 sets forth especially preferred embodiments of attractant wax emulsion compositions (Nos. 1-3) and synergist wax emulsion compositions (Nos. 4-5) prepared in accordance with the present invention. All percentages are by weight:

TABLE 1

| No. 1 | No. 2 | No. 3 | No. 4 | No. 5 |
|---|---|---|---|---|
| 30 percent | 30 percent | 30 percent | 30 percent | 10 percent |
| ammonium | Torula | Protein | trimethylamine | putrescine |
| acetate or | Yeast | | | |
| 30 percent | | | | |
| ammonium | | | | |
| bicarbonate | | | | |
| 48 percent | 48 percent | 48 percent | 48 percent | 82 percent |
| Gulf Wax | Gulf Wax | Gulf Wax | Gulf Wax | Gulf Wax |
| 6 percent | 6 percent | 6 percent | 6 percent | — |
| Soy Oil | Soy Oil | Soy Oil | Soy Oil | |
| 3 percent | 3 percent | 3 percent | 3 percent | — |
| Span 60 | Span 60 | Span 60 | Span 60 | |
| 8 percent | 8 percent | 8 percent | 8 percent | 8 percent |
| microcrystalline | microcrystalline | microcrystalline | microcrystalline | microcrystalline |
| cellulose | cellulose | cellulose | cellulose | cellulose |
| 5 percent | 5 percent | 5 percent | 5 percent | — |
| carrageenan | carrageenan | carrageenan | carrageenan | |

A preferred embodiment of a method for preparing an attractant wax emulsion composition in accordance with the present invention will now be described. In accordance with the method, the desired amount of wax is first weighed out and placed in a metal container. The wax is preferably then heated until melted. Once the wax is melted, the oil is added and the container is preferably immersed in a water bath maintained at a constant temperature which ranges generally from about 45° C. to about 65° C., preferably from about 50° C. to about 60° C. and which is more preferably about 55° C.

The wax is then preferably mixed with a submerged propeller blade operated at a speed ranging generally from about 300 rpm to about 400 rpm and preferably from about 330 rpm to about 380 rpm, with a speed of about 365 rpm being especially preferred. While mixing at this speed, the emulsifying agents (for example, Span 60, microcrystalline cellulose, and carrageenan) are preferably added in the amounts set forth above.

Mixing is preferably continued at the selected propeller speed. Once the mixture obtains a uniform consistency, the desired attractant (e.g., ammonium acetate, ammonium bicarbonate, protein or yeast) is preferably added, after which the mixing speed is increased to a range generally from about 1100 to about 1600 rpm, preferably from about 1200 to about 1500 rpm, and more preferably to about 1430 rpm. The mixing speed is preferably maintained at the increased rate until the emulsion temperature reaches a temperature of from about 45° C. to about 650° C., preferably from about 50° C. to about 60° C. and more preferably about 55° C. At this point, a fluffy, whipped consistency is obtained. Synergist wax emulsion compositions comprising tri-substituted ammonia compounds such as trimethyl amine are preferably prepared using the same method described above for preparing attractant wax emulsion compositions.

A preferred method of preparing a putrescine wax emulsion synergist composition will now be described. In accordance with the method, the desired amount of wax is first weighed out and placed in a metal container. The wax is preferably then heated until melted. Once the wax is melted, the emulsifier is added. The putrescine is then added and blended. Unlike the attractant and trimethyl amine emulsions, the blending of the putrescine emulsion components is not carried out using high speed mixing.

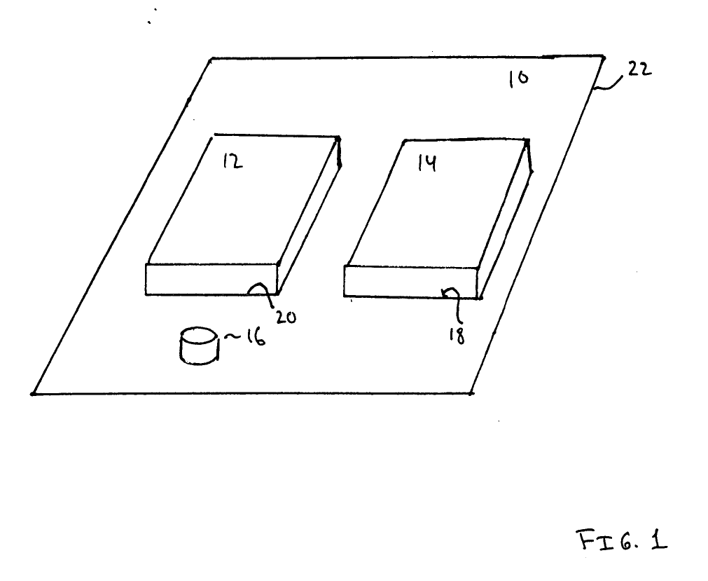

As indicated previously, compositions of the present invention are preferably suitable for use in insect lures. Referring to FIG. 1, a preferred embodiment of a lure 10 suitable for deploying compositions of the present invention will be described. Lure 10 preferably comprises dispensing compartments 12, 14, and 16.

The lure 10 of FIG. 1 comprises multiple dispensing compartments. However, a variety of different lure shapes and configurations can be used. For example, lure may comprise only a single compartment. In addition, compartments 12 and 14 may be round or irregularly shaped. For attracting Mediterranean fruit flies, a three compartment design such as the one depicted in FIG. 1 is preferred.

Each dispensing compartment preferably houses an attractant or synergist composition. If the lure of FIG. 1 is used to target Mediterranean fruit flies (Ceratitis capitata), compartment 12 preferably houses an attractant composition, which more preferably is a wax emulsion composition comprising ammonium acetate. Compartment 14 preferably houses a first synergist composition, which more preferably is a wax emulsion comprising trimethyl amine. Compartment 16 preferably houses a second synergist composition, which more preferably is a putrescine wax emulsion. For Med fly monitoring, it is especially preferred that the compositions contained in compartments 12, 14, and 16 are Compositions 1 (with ammonium acetate), 4, and 5, respectively, as set forth in Table 1 (above). For Med fly monitoring, it is also preferred to use equal amounts (by weight) of Compositions 1 and 4 in compartments 12 and 14 and a lesser amount of Composition 5 in compartment 16. In an exemplary embodiment, compartments 12 and 14 comprise about 2 to about 20 grams of Composition 1 and Composition 4, respectively, with amounts ranging from about 5 to about 15 grams and from about 8 to about 10 grams being preferred and more preferred, respectively. In contrast, compartment 16 preferably comprises Composition 5 in an amount ranging from about 0.1 to about 1 gram, with amounts ranging from about 0.2 to about 0.8 grams and from about 0.4 to about 0.6 grams being preferred and more preferred, respectively.

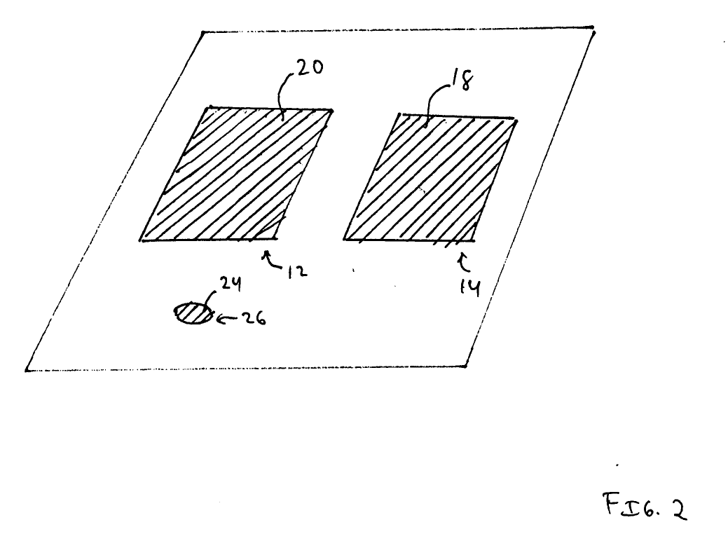

FIG. 2 shows a bottom perspective view of the lure of FIG. 1. As indicated in the figure, each compartment , and 16 preferably includes a semipermeable membrane (18, 20, and 26, respectively) on the bottom 22 of the lure. The lure is preferably a microporous membrane that is selected to obtain a desired release rate of volatile attractants from the lure. Suitable membranes include polyethylene microporous membranes such as the Tredegar BF 116 membrane (Tredegar Corp., Richmond, Va.

Each compartment , and 16 preferably defines an area on bottom surface 22 which is sized to obtain a desired flux of volatiles from lure 10. Compartments 12 and 14 generally comprise an area ranging from about 10 cm² to about 20 cm², with areas ranging from about 12 cm² to about 18 cm² and from about 14 cm² to about 16 cm² being preferred and more preferred, respectively. Compartment 16 preferably comprises an area ranging generally from about 0.5 cm² to about 2 cm², with areas of from about 0.8 cm² to about 1.5 cm² and from about 0.9 cm² to about 1.1 cm² being preferred and more preferred, respectively.

Although not shown in the figures, lure 10 preferably includes a release liner or other removable backing on bottom 22 which preserves the contents of the lure until it is ready to be deployed.

Again without wishing to be bound by any theory, it is believed that lures comprising ammonium acetate which are prepared in accordance with this preferred embodiment generate volatile ammonia which specifically attracts the Mediterranean fruit fly. The lure of this preferred embodiment generally generates volatile ammonia at a rate of from about 100 micrograms per hour to about 600 micrograms per hour, with hourly rates ranging from about 200 to about 500 micrograms being preferred and hourly rates ranging from about 300 to about 400 micrograms being more preferred. An ammonia rate of about 350 micrograms per hour is especially preferred.

The foregoing preferred embodiment of an ammonium acetate/trimethyl amine/putrescine lure is especially preferred for attracting the Mediterranean fruit fly. However, lure 10 can also be used to attract other populations of fruit flies. For example, compartments , and/or 16 may include food-based attractants such as a protein wax emulsion comprising NuLure or SOLULYS® and one of the waxes described above. Lure 10 may also include a Torula yeast wax emulsion. Unlike lures using combinations of ammonium acetate, trimethyl amine, and putrescine, lures using food-based attractants such as corn proteins or yeast will tend to attract a greater diversity of fruit fly species as opposed to targeting Mediterranean fruit flies. If food-based attractant compositions are used, lure 10 preferably comprises a single food-based attractant wax emulsion composition. However, the composition may be contained within a single compartment or within multiple compartments such as those shown in FIG. 1.

In accordance with another preferred embodiment, lure 10 is configured to preferentially attract Anastephra ludens. In accordance with this preferred embodiment, lure 10 comprises one attractant composition and one synergist composition. The attractant composition is preferably an ammonium acetate wax emulsion, comprising the amounts of ammonium acetate, wax, and emulsifier described above. Lure 10 preferably contains separate compartments, one which houses the ammonium acetate wax emulsion and one which houses the-putrescine wax emulsion.

In accordance with another preferred embodiment, lure is configured to preferentially attract Bactrocera olea. In accordance with this preferred embodiment, lure 10 comprises an ammonium bicarbonate attractant wax emulsion composition which is housed in one or more compartments such as compartments 12, 14, and/or 16. If lure 10 is configured to target Bactrocera olea, a synergist composition is preferably not used. As the foregoing examples indicate, those of ordinary skill in the art can select a wax emulsion attractant composition prepared in accordance with the present invention which targets an insect population of interest.

The preferred embodiments of attractant compositions and lures described above may be used with a trap to capture an insect population of interest. An especially preferred embodiment of a trap suitable for housing lures of the present invention is described in Alvarado, U.S. Pat. No. 6,532,695 (the“'695 Patent”) the entirety of which is hereby incorporated by reference. The traps disclosed and claimed in the '695 Patent are sold under the name“Multilure” by the Better World Manufacturing Company (Fresno, Calif.).

Referring to the '695 Patent's disclosure, an insect trap 11 is disclosed which comprises first member 13 and second member 15. First member 13 is generally cylindrical in shape and includes a plug 41 which may be used to vent the trap. Second member 15 is generally annular in shape and has an open end 71 which mates with a corresponding open end 21 of first member 13. Second member 15 also has a toroidal end 67 which defines an opening 73 through which insects may enter trap 11.

Second member 15 defines an annular reservoir 111. If trap 11 is configured as a wet trap (as shown in the '695 Patent figures), reservoir 111 is preferably filled with a retention agent. The retention agent preferably kills attracted insects by drowning. Suitable retention agents include water, a mixture of water and surfactant such as the TRITON® family of surfactants (Rohm and Haas, Philadelphia, Pa.), a mixture of water and propylene glycol, and a mixture of water and borax. A water/TRITON® retention agent is especially preferred for wet trap configurations. Borax acts as a preservative which reduces the decomposition of captured insects. Thus, if odor reduction is desired, water/borax retention agents may be used.

Referring again to the '695 Patent, lure 127 (which is preferably lure of FIG. 1 herein) is preferably housed within trap 11. For wet trap configurations, the lure 10 is preferably secured within the trap in a manner that avoids contact with the liquid retention agent. For example, lure 10 may be secured to frusto-conical portion 25 of first member 13 by using tape 131 or by incorporating an adhesive onto the lure itself. The lure may also be supported by the plurality of offset finger projections 35 extending inside first end 17.

The '695 Patent is directed to wet trap configurations. However, in accordance with an especially preferred embodiment of the present invention, a dry trap configuration is used. For dry trap configurations, a non-liquid retention agent is used. A “DDVP”(2,2 dichlorovinyl dimethyl phosphate, also known as 2,2 dichloroethenyl dimethyl phosphate) retention agent is especially preferred. The DDVP retention agent is preferably a toxicant which is lethal to the attracted insects. Other suitable dry retention agents include methomyl, malathion, naled, organophosphorous toxicants, carbamates, inorganic toxicants, avermectin, spinosad, phloxine B, or other toxicants that kill insects by contact or inhalation. If a retention agent is used, it is preferably selected to avoid adversely affecting the attractiveness of the attractant composition. For wet trap configurations, the lure may be placed in the positions described above. However, for dry trap configurations the lure is preferably placed in reservoir 111.

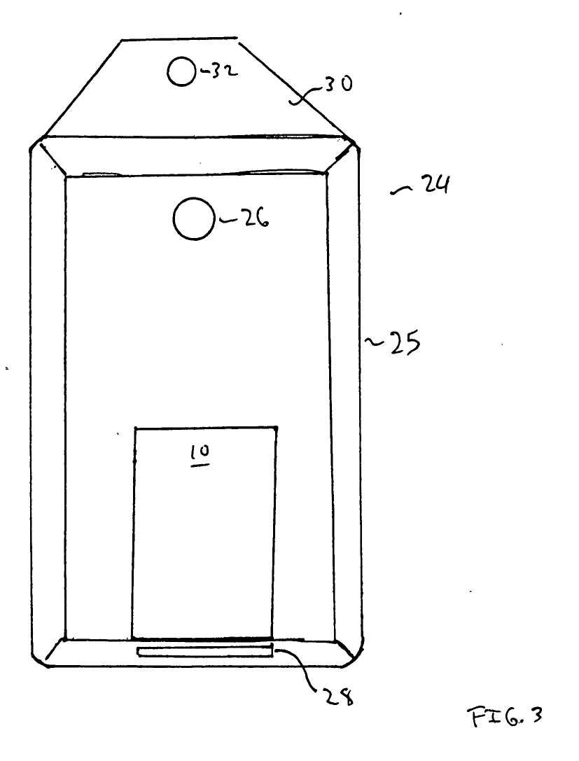

Referring to FIG. 3, an alternate embodiment of a trap is depicted. The trap of FIG. 3 is similar to a commercially available trap known as the“Easy Trap” sold by the Sorygar company. Trap 24 includes housing 25, which in this preferred embodiment is generally rectangular in cross-section. Although not shown in the figure, trap 24 also preferably includes a cover which fits over housing 25 to define an enclosed volume within trap 24. Lure may be placed at the bottom of the trap as shown or hung vertically by a hook or other supporting structure. Lure preferably contains an attractant composition as described above. In addition, lure is preferably oriented such that bottom surface 22 faces inward. By orienting lure inwardly, abutting contact of bottom surface 22 with housing 24 is avoided, which facilitates the release of volatile materials generated by lure 10.

Inlet hole or port 26 is preferably provided to facilitate the emission of volatile material generated by lure as well as to provide a means of entry for insects attracted to trap 24. Similarly, the cover may include an inlet or port, if desired.

Trap 24 is preferably configured to retain insects which enter it. Accordingly, a retention agent 28 may be provided. The preferred embodiment of FIG. 3 is a“dry trap” which may use one of the dry retention agents described above. However, for dry trap configurations, however, DDVP is preferred.

Although the preferred embodiment of FIG. 3 is a dry trap, the present invention may also be used with wet traps which incorporate one of the liquid retention agents described above. As with the previous trap embodiment, a water/TRITON® retention agent is especially preferred for wet trap configurations. Also, if a wet trap is used, lure is preferably vertically hung within trap 24 to avoid contact with the retention agent.

Although the traps described above are preferred, a variety of different traps may be used with the lures, attractant compositions and synergist compositions of the present invention. For example, the Sorygar tephri-trap may be used in addition to those described above.

Because of their ability to attract insects, attractant compositions prepared in accordance with the present invention are well-suited for capturing and retaining undesirable insects, as well as for monitoring or mass trapping insect populations.

A preferred embodiment a method for monitoring insect populations in accordance with the present invention will now be described. In accordance with the method, a trap 24 is provided which includes lure 10. Lure 10 is formulated to attract one or more insect species of interest as described above. Retention agent 28 is preferably included and may be a dry agent or a wet agent, as described above.

In accordance with the method, at least one trap 24 is placed in a location believed to be inhabited by the targeted insect species. For example, trap 24 may be placed in an orchard, such as a citrus, mango, papaya, or olive orchard. Trap 24 is preferably left in the location for a fixed period of time which generally ranges from about 1 day to about 14 days, preferably ranges from about 5 days to about 10 days, and more preferably from about 6 days to about 8 days.

After the fixed period of time, the trap is preferably opened and the number of insects contained in it is counted. If desired, the captured insects are segregated by their species, and the number of each species of interest is determined. Using known techniques, the population of insects of all captured species or of each captured species in the location is estimated. The trap is then returned to its location to continue monitoring or mass trapping the insect population.

In a preferred embodiment, the number of traps, the estimated total area of infestation, the duration of trap deployment, and the number of flies per trap per day (FTD) are used to estimate the insect populations of interest. The FTD is a population index that estimates the number of flies captured in one trap in one day that the trap is exposed in the field. It can be used to provide a relative measurement of the size of the adult pest population in a given space and time and can also be used to determine the efficacy of a pest control program (by calculating the FTD before and after the application of the program. The FTD is preferably calculated as follows:
FTD=F/ (T×D)

wherein F is the total number of flies in the trap, T is the total number of serviced traps, and D is the average number of days the traps were exposed in the field.

The embodiments described above are exemplary embodiments of the present invention. Those skilled in the art may now make numerous uses of, and departures from, the above-described embodiments without departing from the inventive concepts disclosed herein. Accordingly, the present invention is to be defined solely by the scope of the following claims.

What is claimed is:

1. A lure, comprising:
a first attractant composition comprising a first attractant and a first wax; and
a first synergist composition comprising a first synergist and a second wax.

2. The lure of claim 1, further comprising a second synergist composition comprising a second synergist and a third wax.

3. The lure of claim 1, wherein the first wax is a paraffin.

4. The lure of claim 1, wherein the first attractant is selected from the group consisting of a chemical attractant, a food-based attractant, and mixtures thereof.

5. The lure of claim 1, wherein the first attractant is selected from the group consisting of ammonium acetate, ammonium bicarbonate, protein, yeast, and mixtures thereof.

6. The lure of claim 1, wherein the first attractant is ammonium acetate and the first synergist is trimethyl amine.

7. The lure of claim 1, wherein the first attractant is ammonium acetate and the first synergist is putrescine.

8. The lure of claim 2, wherein the first attractant is ammonium acetate, the first synergist is trimethyl amine, and the second synergist is putrescine.

9. The lure of claim 1 wherein the lure comprises a first dispensing section and a second dispensing section, the first attractant composition is disposed in the first dispensing section and the first synergist composition is disposed in the second dispensing section.

10. The lure of claim 2, wherein the lure comprises a first dispensing section, a second dispensing section, and a third dispensing section, the first attractant composition is disposed in the first dispensing section, the first synergist composition is disposed in the second dispensing section, and the second synergist composition is disposed in the third dispensing section.

11. The lure of claim 1, wherein at least one selected from the group consisting of the first attractant composition and the first synergist composition is an emulsion.

12. The lure of claim 2, wherein the first attractant composition and the first synergist composition are each an emulsion.

13. The lure of claim 1, wherein the first attractant is present in an amount sufficient to attract an insect species.

14. The lure of claim 13, wherein the insect species is at least one selected from the group consisting of Ceratitis, Bactrocera, Rhagoletis, Anastrepha, and Dacus.

15. The lure of claim 1, wherein the first attractant is present in an amount greater than about 1 percent by weight.

16. The lure of claim 1, wherein the first synergist is present in an amount greater than about 1 percent by weight.

17. An insect trap comprising the lure of claim 1.

18. The insect trap of claim 17, further comprising an insect retention agent.

19. The insect trap of claim 18, wherein the insect retention agent is selected from the group consisting of 2,2 dichlorovinyl dimethyl phosphate, water, a mixture of water and surfactant, a mixture of water and propylene glycol, and a mixture of water and borax.

20. The lure of claim 1, wherein the lure releases ammonia at a rate of from about 100 micrograms per hour to about 600 micrograms per hour.

21. The lure of claim 20, wherein the rate of release of ammonia is substantially constant during a fixed period of time.

22. A composition comprising a wax and an attractant selected from the group consisting of ammonium acetate, ammonium bicarbonate, protein, yeast, and mixtures thereof, wherein the attractant is present in an amount ranging from greater than 1.0 percent by weight to less than 50 percent by weight.

23. The composition of claim 22, wherein the amount of the attractant is from about 5 percent to less than 50 percent by weight of the composition.

24. The composition of claim 22; wherein the amount of wax is from about 40 percent to about 60 percent by weight of the composition.

25. The composition of claim 22, wherein the composition releases ammonia at a rate of from about 100 micrograms per hour to about 600 micrograms per hour.

26. The composition of claim 25, wherein the release rate of ammonia is substantially constant during a fixed period of time.

27. A lure comprising the composition of claim 22.

28. An insect trap comprising the lure of claim 27.

29. The composition of claim 22, wherein the wax is a paraffin.

30. The composition of claim 22, wherein the composition further comprises an emulsifier.

31. A method of monitoring an insect population in a location, comprising:
providing an insect trap including the lure of claim 1;
placing the trap in the location for a period of time, wherein a number of insects are contained in the trap at the end of the period; and
determining the number of insects contained in the trap.

32. The method of claim 31, wherein the period of time is a first period of time, the number of insects contained in the trap is a first number of insects contained in the trap, and the method further comprises the steps of placing the trap in the location for a second period of time, wherein a second number of insects are contained in the trap at the end of the second period, and determining the second number of insects contained in the trap.

33. The method of claim 31, wherein the insect trap further comprises an insect retention agent.

34. The method of claim 31, wherein the first attractant is selected from the group consisting of ammonium acetate, ammonium bicarbonate, protein, yeast, and mixtures thereof.

35. The method of claim 31, wherein the lure includes a first dispensing section and a second dispensing section, the first attractant composition is contained in the first dispensing section, and the first synergist composition is contained in the second dispensing section.

36. The method of claim 31, wherein the first attractant is ammonium acetate, and the first synergist is trimethyl amine.

37. The method of claim 31, wherein the first attractant is ammonium acetate, and the first synergist is putrescine.

38. The method of claim 31, wherein the lure further comprises a second synergist composition comprising a second synergist and a third wax, the first attractant is ammonium acetate, the first synergist is trimethyl amine, and the second synergist is putrescine.

39. The method of claim 31, wherein the first attractant is present in an amount sufficient to attract an insect species.

40. The method of claim 39, wherein the insect species is at least one selected from the group consisting of Ceratitis, Bactrocera Anastrepha, Rhagoletis, and Dacus.

41. The method of claim 33, wherein the insect retention agent is selected from the group consisting of 2,2 dichlorovinyl dimethyl phosphate, water, a mixture of water and emulsifier, a mixture of water and propylene glycol, and a mixture of water and borax.

42. The method of claim 31, wherein at least one of the first attractant composition and the first synergist composition further comprises an emulsifier.

43. The method of claim 31, wherein at least one of the first wax and the second wax is a paraffin.

44. A composition for attracting insects, comprising an attractant, present in an amount ranging from greater than 1.0 percent by weight to less than about 50 percent by weight, and a wax.

45. The composition of claim 44, wherein the attractant is one selected from a chemical attractant, a food-based attractant, and mixtures thereof.

46. The composition of claim 44, wherein the attractant is selected. from the group consisting of ammonium acetate, ammonium bicarbonate, protein, yeast, and mixtures thereof.

47. The composition of claim 44, wherein the attractant is present in an amount ranging from about 5 percent to about 40 percent by weight.

48. The composition of claim 44, wherein the attractant is present in an amount ranging from about 25 percent to about 35 percent by weight.

49. The composition of claim 44, further comprising an emulsifier.

50. A method of monitoring a population of insects, comprising:
providing a trap having a lure disposed in the trap, wherein the lure comprises the composition of claim 44;
placing the trap in an area inhabited by the insects for a period of time, wherein a number of insects are contained in the trap at the end of the period;
determining the number of insects contained in the trap.

51. The method of claim 50, wherein the period of time is a first period of time, the number of insects contained in the trap is a first number of insects contained in the trap, and the method further comprises placing the trap in an area inhabited by the insects for a second period of time, wherein a second number of insects are contained in the trap at the end of the period, and determining the second number of insects contained in the trap.

52. A composition for attracting insects, comprising an attractant and a wax, wherein the attractant is selected from the group consisting of protein, yeast, and mixtures thereof.

53. A lure comprising the composition of claim 52 and a synergist.

54. The lure of claim 53, wherein the synergist is a tri-substituted ammonia compound.

55. The lure of claim 53, wherein the synergist is selected from the group consisting of trimethyl amine and putrescine.

56. The composition of claim 52, further comprising an emulsifier.

57. The composition of claim 52, wherein the amount of attractant ranges from about 5 percent to less than 50 percent by weight.

58. A method of monitoring a population of insects, comprising:
providing a trap having a lure disposed in the trap, wherein the lure comprises the composition of claim 52;
placing the trap in an area inhabited by the insects for a period of time, wherein a number of insects are captured in the trap;
determining the number of insects captured in the trap.

59. The method of claim 58, wherein the population of insects comprises at least one species selected from the group consisting of Ceratitis, Bactrocera, Anastrepha, Rhagoletis, and Dacus.

60. A lure comprising at least one wax emulsion composition formulated to release from about 100 micrograms per hour to about 600 micrograms per hour of ammonia.

61. The lure of claim 60, wherein the at least one wax emulsion composition is formulated to release from about 300 to about 500 micrograms per hour of ammonia.

62. The lure of claim 60, wherein the wax emulsion is formulated to release ammonia at a substantially constant rate during a fixed period of time.

63. The lure of claim 60, wherein the at least one wax emulsion composition comprises two wax emulsion compositions.
